(19) United States
(12) Patent Application Publication
(10) Pub. No.: US 2008/0180790 A1
(43) Pub. Date: Jul. 31, 2008

(54) Dynamic Scanning Automatic Microscope and Method

(75) Inventors: Triantafyllos Tafas, Rocky Hill, CT (US); Yanning Zhu, Hamden, CT (US)

Correspondence Address: KELLEY DRYE & WARREN LLP, 400 ALTLANTIC STREET , 13TH FLOOR, STAMFORD, CT, 06901, US

(73) Assignee: Ikonisys, Inc., New Haven, CT (US)

(21) Appl. No.: 11/833,594

(22) Filed: Aug. 3, 2007

Related U.S. Application Data
(60) Provisional application No. 60/821,552, filed on Aug. 4, 2006.

(51) Int. Cl. G02B 21/36

(52) U.S. Cl. 359/363

(57) ABSTRACT

An automatic microscope is disclosed which incorporates dynamic scanning of the microscope slide and other interchangeable optical path components.

### CROSS REFERENCE TO RELATED APPLICATIONS

This application claims priority from U.S. Provisional Application No. 60/821,552. All references cited in this specification, and their references, are incorporated by reference herein where appropriate for teachings of additional or alternative details, features, and/or technical background.

### BACKGROUND OF THE INVENTION

Field of the Invention

Automated microscope technologies are finding application in the field of medicine. As an example, the analysis of bodily tissue which has been subjected to fluorescence in-situ hybridization or FISH, has become an effective tool in the diagnosis of chromosomal abnormalities. When irradiated by stimulating illumination, hybridized or bonded markers identify targeted portions of the DNA chain by radiating fluorescent light at defined wavelengths. These fluorescent light dots are detectable under the microscope. The analysis is performed by counting the FISH dots and determining the distributions of FISH dots of different colors.

Diagnostic FISH light dot counting has been conventionally performed manually, by a skilled microscopist. In addition to correctly identifying the dot and it's color, other size and shape characteristics must be categorized to correctly identify the chromosomal condition. The analysis is made more difficult by the time constraints imposed by the phenomena. The microscopist, therefore, must be exhaustively trained to perform the examination. Even under the best conditions, the process has proven to be tedious, lengthily and subject to human error.

The application of automated microscopy has the potential to overcome many of the shortcomings of the manual approach. The automatic microscope can reliably identify the fluorescent dots in a tissue sample, accurately determine their color, categorize them based on shape and size, and perform the summary analysis necessary to determine the presence or absence of the targeted condition without the inevitable subjective factors introduced by a human operator all in a timely manner.

The protocol required for examination of the tissue sample, using an automatic microscope, requires that the slide or slides containing the specimen be positioned so that each area of interest is within the field of view. Usually, however, the microscope's field of view is significantly smaller than the area of the specimen. In addition, the thickness or depth of the specimen presented on the microscope slide might be significantly greater than the microscope's depth-of-focus. These factors make it necessary to mechanically reposition the specimen containing slide to sequentially examine the entire sample. This repositioning is conventionally performed by a microscope stage which typically includes linear actuators capable of displacing the slide in three orthogonal axis.

In operation, the subject slide containing the specimen is loaded into the microscope stage. The stage actuators position the slide under the microscope ocular and hold it stationary, in place. The X-axis and Y-axis actuators determine the field of view selected for examination while the Z-axis actuator determines the plane of focus. The sample is then illuminated and an image is captured. A separate image is taken for each wavelength as determined by the position of a filter wheel inserted along the optical path. After the image is captured the stage again repositions the slide to the next stationary position, in three dimensions, and the next image is captured. This process is repeated until the entire sample is imaged. The time required to reposition and hold the slide for each image may be significant. In addition, each start/stop repositioning movement causes mechanical vibrations. The system must pause after each movement, to allow the vibration to damp out.

A typical FISH examination protocol may, for example, require the imaging and analysis of 200 specimen slides. In addition, due to the depth of the specimen, images must be taken, typically, at each of 9 focal planes and three wavelengths. The small field of view of the microscope may require tens of slide x,y positionings to cover each focal plane of each slide. The total time required to perform a single diagnosis may thus become unacceptably long. A significant reduction the time to perform the diagnosis would therefore be highly desirable.

### SUMMARY OF THE INVENTION

In an embodiment disclosed herein, an automated microscope is described which has the ability to significantly reduce the time required to perform the examination, the vibration caused by and provide diagnostic results. During the imaging process, the stage and color filter wheel are in constant motion rather than stationary as in previous approaches. Real time position sensors on each of the moving sub-systems accurately telemeter the instant position of the stage mounted slide and the color filter wheel. The color filter wheel rotates at a sufficient speed to allow the capture of images, at each of the filter wavelengths, at each imaging location and focal plane. The effective shutter speed of the imaging device is adequate to “freeze” the motions of the slide and color wheel so that an acceptable image may be recorded. Conventional digital image processing techniques may be employed to correct for the small lateral displacements resulting from stage motion.

While this brief summary describes a system comprising a stage and color wheel only, the concept may be readily extended to other interchangeable optical path components and illumination sources.

Embodiments disclosed herein include A dynamic scanning automatic microscope system comprising: an automatic microscope that incorporates a microscope slide stage comprising actuators configured to continuously position the microscope slide in each of three orthogonal axis; at least one source of illumination energy positioned to continuously irradiate specimen mounted on the microscope slide; at least one electronic imaging device positioned to continually capture image of the specimen; at least one interchangeable component carousel configured to continuously and cyclically insert interchangeable components into optical axis of the automatic microscope; a synchronization controller operatively connected to the actuators, the at least one source of energy, the at least one electronic imaging device, and the at least one interchangeable component carousel, the synchronization controller operatively configured to continuously generate control signals and to receive telemetry. Embodiments also include a dynamic scanning automatic microscope system where the the interchangeable components are filters, lenses, illumination sources, and/or image capture sources. Embodiments also include that electronic imaging device may additionally comprise an image intensification device and the system may further include an image processor.

Embodiments disclosed herein further include a method for dynamically scanning a specimen mounted on a microscope slide on a dynamic scanning microscope incorporating a microscope slide stage, at least one source of illumination energy, at least one electronic imaging device, at least one interchangeable component carousel and a synchronization controller, the method comprising the steps of: mounting the microscope slide on the microscope slide stage; generating control signals in the synchronization controller and supplying the control signals to the microscope slide stage, the at least one source of illumination energy, the at least one electronic imaging device, and the at least one interchangeable component carousel; continuously moving the microscope slide stage in response to the control signals in a predetermined manner; continuously cycling the carousel in response to the control signals; continually capturing images in response to the control signals while the stage or the carousel is in motion. The method may include transmitting telemetry from the microscope slide stage, illumination sources, electronic imaging devices, and/or interchangeable component carousel to the synchronization controller. The method may also include the step of employing image processing techniques to improve image quality.

### BRIEF DESCRIPTION OF DRAWINGS

The embodiments are described with the aid of the following drawings:

FIG. 1 is a simplified drawing of an embodiment of the dynamic scanning automatic microscope.

FIG. 2 is a simplified drawing of an embodiment of an interchangeable filter carousel.

FIG. 3 is a simplified drawing of an embodiment of a microscope slide stage comprising X, Y, and Z axis linear actuators.

FIG. 4 is a simplified drawing of an embodiment of the Z axis linear actuator and attached slide holder.

### DETAILED DESCRIPTION OF THE INVENTION

In an embodiment, an automated microscope system comprises a slide positioning stage and interchangeable components which are configured to permit continuous cyclical insertion into the optical path. These interchangeable components, which may be configured on actuator driven carousels, may include filters, lenses, light baffles, illumination sources and/or imaging devices. In an embodiment, epi- and epo-illumination sources may be cycled to capture both reflection and transmission images. The position of the stage and each of the interchangeable component carousels is determined by respective feedback-loop controlled actuators. The instant location of each is accurately and precisely telemetered to a synchronization controller.

In operation, a specimen slide is loaded into the stage. The X-axis and Y-axis linear actuators scan the X, Y position of the slide at a constant speed so that the entire specimen area passes within the field of view of the microscope. Simultaneously, the Z-axis actuator of the stage scans the Z position of the slide, so that the focal plane of the microscope correspondingly scans the full depth of the specimen, including the “best focused” focal plane for each object of interest. At the same time, the carousel containing the chosen selection of filters is rotated so that each filter remains in the optical path for an adequate time to acquire an image. The image acquisition exposure time, and corresponding filter insertion time, are sufficiently short to “freeze” the motion of the stage.

Images are exposed based on the examination protocol and the synchronization control signals emanating from the synchronization control generator. The state of each of the interchangeable components as well as the instant position of the stage is recorded with each exposure. The separate wavelength images, resulting from exposure through their respective interchangeable filters, are combined to allow analysis of FISH structures. The registration of the images being combined may be corrected using conventional image processing techniques.

The relative timing of each of the microscope components is interrelated and synchronized. The imaging device may be characterized by its exposure time (i.e., the duration of the exposure) and its inter-exposure cycle time (i.e., the time between exposures). These times are determined by the imaging device technology. The exposure time must be sufficiently brief to insure that movement of the specimen slide and the filter wheel is effectively frozen. Typically, at least three exposures must be taken for each placement of the specimen. The rotation of the filter wheel should place the next sequential filter in the optical path at a time interval corresponding to the imaging device's inter-exposure cycle time. A set of three exposures, corresponding to three different wavelengths should be captured for each Z-axis depth of the specimen. As an example, images at nine focal planes may be required to completely characterize the specimen at a single x,y position. Thus a total of 27 exposures would be required for each microscope field of view. The z-axis actuator should provide displacement satisfying all of these timing requirements. The specimen must be scanned in the x,y plane to fully image the specimen. The scanning speed in the x,y plane, must be therefore permit the capture of 27 images for each microscope field-of-view. Image processing may be employed to correct registration between images necessitated by the various motion.

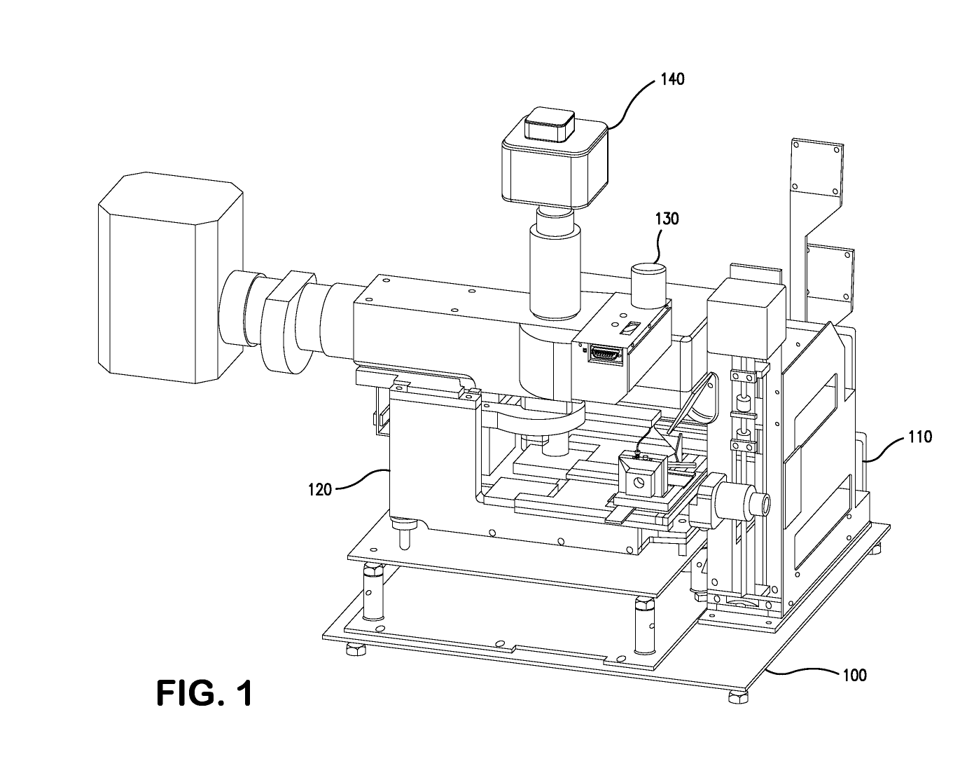

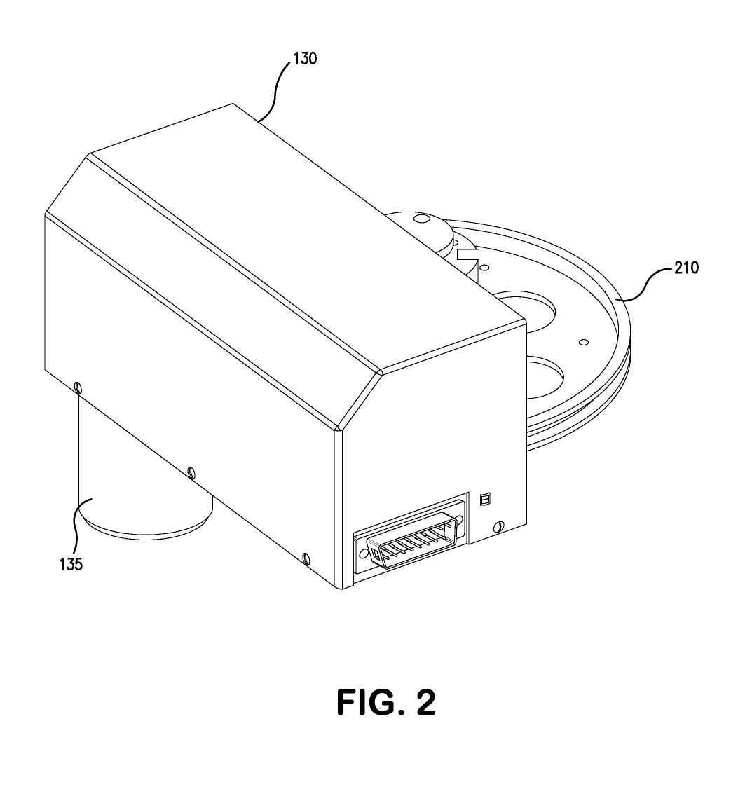

In an embodiment, a side view of an automated microscope is provided as FIG. 1. The stage 100 transfers the specimen slides from the cassette loaded in cassette handler 110 to microscopes optical axis 120. Interchangeable filter carousel 130, as shown in FIG. 2, is located on the microscope, so that individual interchangeable filters 210 may be positioned on optical axis 120. Filter carousel 130 is rotated by synchronized motor 135.

Electronic imaging device 140 may be a multi-pixel planar array of light sensitive charge coupled device (CCD) or complementary metal oxide semiconductor (CMOS) elements or any other technology suitable for converting an optical image into electrical signals. Low intensity detection can be enhanced through the employment of image intensifier and similar technologies.

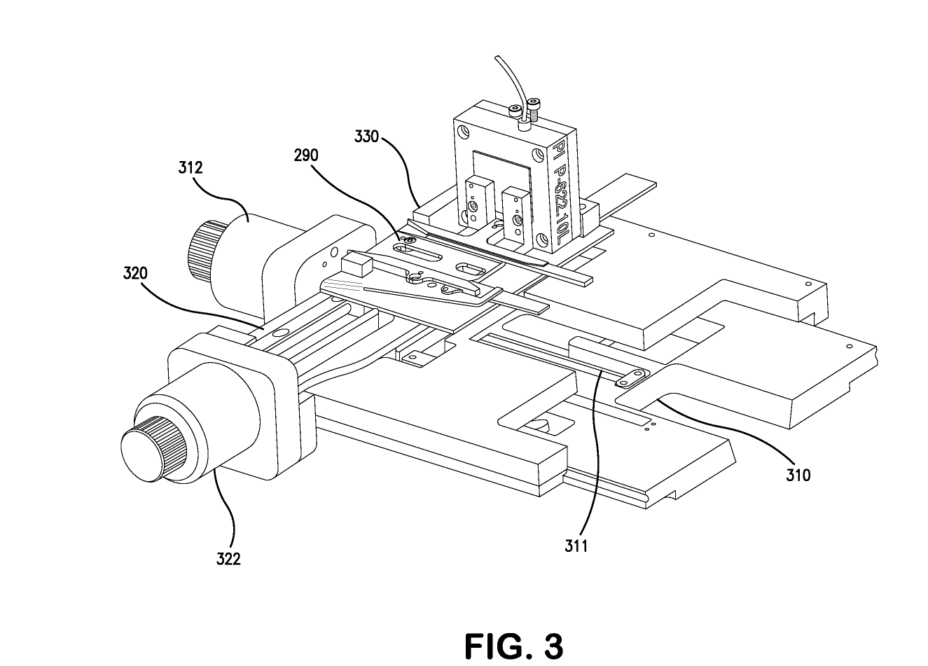

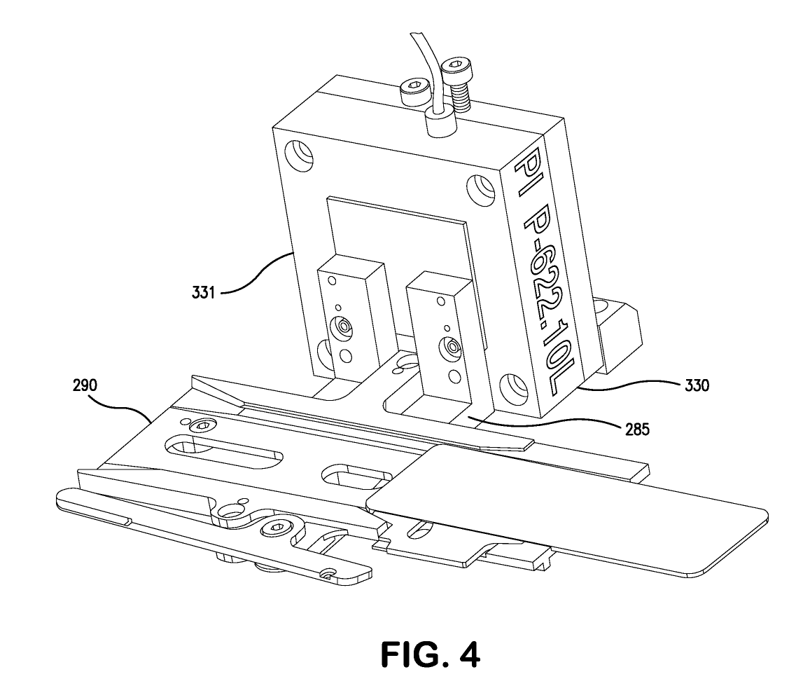

In an embodiment, the stage is comprised of three linear actuators as shown in FIG. 3. Slide holder stage 290 is comprised of three orthogonally oriented linear actuators 310, 320, 330 that are mechanically coupled to provide the required displacement. X-axis linear actuator 310 is lead-screw mechanism 311 driven by motor 312, which moves a lead-screw nut along the X-axis. Y-axis linear actuator 320 is mechanically connected to lead-screw nut of X-axis linear actuator 310. Y-axis linear actuator 320 is driven by motor 322 that moves lead-screw nut 323 along the Y-axis. Z-axis linear actuator 330 is mechanically connected to lead-screw nut of the Y-axis linear actuator. The Y-axis linear actuator, as shown in FIG. 4, is comprised of piezo-electric transducer 331 that converts an electrical control signal into a proportional linear displacement. Slide holder base 285 is mechanically fastened to piezo-electric transducer 331 so that the application of an electrical signal results in a linear displacement along the Z-axis. Thus slide holder base 285 may thus be positioned in the three Cartesian coordinates by applying the appropriate control signals to the three actuators.

The configuration of Z-axis linear actuator 330, mounted on X-axis 310 and Y-axis actuators 320, serves to minimize the mass which must be displaced to provide Z-axis displacements. The Z-axis scanning control signal may have a sintisoidal, triangle or other suitable shape, thus resulting in a corresponding displacement. The frequency of the Z-axis scanning control signal is sufficiently high, relative to the X-axis and Y-axis movement, to allow images to be captured at each of the desired focal lengths, for a given specimen site-of-interest.

While this embodiment provides for the dynamic scanning of the microscope stage and color filter wheel, other embodiments provide for scanning other optical path components and sub-assemblies including but not limited to image capture devices, illumination sources, lenses and optical baffles. In addition to scanning optical components additional embodiments encompass scanning of experiment parameters such as temperature, elapsed time for transient phenomenon, varying pressure etc.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

What is claimed is:

1. A method for dynamically scanning a microscope slide, having a specimen thereon, on a microscope having a stage operatively configured to move in three orthogonal axes in response to a control signal, an activating source activating said specimen, an electronic imaging device operatively configured to produce an image from signals generated by activation of said specimen, and a carousel of interchangeable optical components designed to alter the properties of the signals generated by activation of said specimen:
mounting said microscope slide on said stage;
moving said stage in response to said control signal in a predetermined manner;
cycling said carousel in response to said control signal;
capturing, on said electronic imaging device, an image in response to said control signal while said stage or said carousel is in motion.

2. A dynamic scanning automated scan microscope system comprising:
an automatic scan microscope, having a field of view, that incorporates a microscope slide stage operationally configured to be capable of moving along three orthogonal axes and to hold a microscope slide with a specimen thereon;
at least one stage actuator operatively configured to dynamically position said microscope slide in each of three orthogonal axis; in response to a actuator control signal;
an activating energy source positioned with respect to said specimen on said microscope to irradiate specimen mounted on said microscope slide;
an electronic imaging device positioned on said automatic scan microscope and configured to capture an electronic image of at least a portion of said specimen observable within said field of view an electronic processing device positioned to process optical information said electronic image resulting from said irradiation of said specimen mounted on said microscope slide;
a carousel housing a plurality of optical components, one or more of which are capable of altering said optical information available to said electronic processing device in a manner distinct to other of said plurality of optical components, said carousel being located between said electronic imaging device and said stage and configured to cyclically interchange one of said optical components with another of said optical components upon receipt of a control signal;
a synchronization controller operatively connected to said at least one stage actuator, said electronic processing device, and said carousel, said synchronization controller operatively configured to synchronize the actuation of said stage actuator, said electronic processing device and said carousel movement.

3. A dynamic scanning automatic microscope system, as in claim 2, where the said optical components are selected from the group consisting of filters and lenses.

4. A dynamic scanning automatic microscope system, as in claim 2 where the said optical components comprise illumination sources.

5. A dynamic scanning automatic microscope system, as in claim 2, wherein the said optical components comprise image capture devices.

6. A dynamic scanning automatic microscope system, as in claim 2, further comprising a real-time position sensor operatively coupled with said microscope slide stage.

7. A dynamic scanning automatic microscope system, as in claim 1, further comprising a real-time position sensor operatively coupled with said carousel.

8. A method for dynamically scanning a specimen mounted on a microscope slide on a dynamic scanning microscope incorporating a microscope slide stage, at least one source of illumination energy, at least one electronic imaging device, at least one interchangeable component carousel and a synchronization controller, the method comprising the steps of:
mounting said microscope slide on said microscope slide stage;
generating control signals in said synchronization controller and supplying said control signals to said microscope slide stage, said at least one source of illumination energy, said at least one electronic imaging device, and said at least one interchangeable component carousel;
moving said microscope slide stage in response to said control signals in a predetermined manner;
cycling said carousel in response to said control signals;
capturing images, using said at least one electronic imaging device, in response to said control signals while said stage or said carousel is in motion.

9. A method for dynamically scanning a specimen, in accordance with claim 8, further comprising the step of transmitting telemetry from said microscope slide stage to said synchronization controller.

10. A method for dynamically scanning a specimen, in accordance with claim 9, further comprising the step of transmitting telemetry from said at least one source of illumination energy to said synchronization controller.

11. A method for dynamically scanning a specimen, in accordance with claim 9, further comprising the step of transmitting telemetry from said at least one electronic imaging device to said synchronization controller.

12. A method for dynamically scanning a specimen, in accordance with claim 9, further comprising the step of transmitting telemetry from said at least one interchangeable component carousel to said synchronization controller.

13. A method for dynamically scanning a specimen, in accordance with claim 9, further comprising the step of employing image processing techniques to improve image quality.
